(19) United States
(12) Patent Application Publication
(10) Pub. No.: US 2004/0249932 A1
(43) Pub. Date: Dec. 9, 2004

(54) System and method for generating event notifications

(76) Inventor: Shain W. Bunz, Roseville, CA (US)

Correspondence Address: HEWLETT-PACKARD COMPANY, Intellectual Property Administration, P.O. Box 272400, Fort Collins, CO, 80527-2400, US

(21) Appl. No.: 10/454,976

(22) Filed: Jun. 5, 2003

(51) Int. Cl. G06F 15/173; G06F 15/16

(52) U.S. Cl. 709/224; 709/202

(57) ABSTRACT

A system and method for generating an event notification, e.g., a “trap,” “interrupt,” or “alert,” the system and method comprising storing an identifier identifying a first software program to be notified of an event in connection with a process; said process forming a first data packet including at least one item and an instruction to write said an item to a second software program, said item including an event identifier; said process sending said first data packet to said second software program; said second software program forming a second data packet using said event identifier; said second software program retrieving said identifier for said first software program; and said second software program sending said second data packet to said first software program.

The present invention relates generally to the operation of computer systems and networks and more specifically to the generation of event notifications in computer systems and networks.

In the operation of computer systems and networks, it is often desirable for a software program, e.g., a network management application, to be notified when an event occurs in connection with a process concerned with the operation of hardware devices and software programs that make up a system or network. For example, a printer connected to the network might have its lid opened, and it might be desirable for the network administrator, through his or her management software, to know that the printer is at least temporarily out of service for this reason. In this example, a process running some or all of the functions of the printer would notify the management application of the event of the lid being opened.

Computer systems and networks that provide such event notification use scarce computing resources and time to do so. Because the primary use of many computer systems and networks is to perform a large number of tasks with limited resources in limited periods of time, it is an important goal of system and network management to provide event notifications in a way that economizes the computing resources and/or time used.

A prior method of generating event notifications involves at least three software programs in addition to the process in connection with which an event of interest occurs. A first software program that is to be notified of an event occurring in connection with a process having to with system or network operation is identified as such by the storage of an identifier. This first program may be a management application such as that used in Simple Network Management Protocol (hereinafter, “SNMP”). The process forms a first data packet containing an identifier of the event and an instruction to write that identifier to a second software program. This first data packet may be a set packet such as that used in SNMP. This second program may be a trap daemon such as that used in SNMP and in a variety of operating systems and networks. The process must establish a first interprocess communication mechanism with the second program, then it must send the first data packet to the second program.

The second program must establish a second interprocess communication mechanism with a third computer program that can access the stored identifier of the first program. This third program may be an agent such as that used in SNMP. Using the first communication mechanism, the process provides to the second program the information necessary to form a second data packet. This second packet may be trap packet as used in SNMP and in a variety of operating systems. Using the second communication mechanism, the third program provides the identifier of the first program to the second program. The second program forms the second packet, establishes a third communication mechanism with the first program, and uses the third communication mechanism to send the second packet to the first program, thus notifying the first program of the event of interest.

In some computer systems and networks, it is further required that the third program be notified of the event as well. In that case, at least another interprocess communication mechanism must be established and information sent to the second program, incurring even more time and computing resources than the original generation of the event notification.

### SUMMARY OF THE INVENTION

Systems and methods are disclosed for generating event notifications in computer systems and networks.

The embodiments of the invention disclosed herein include but are not limited to embodiments using SNMP, and further include but are not limited to embodiments generating event notifications known to those skilled in the art as “traps,” “interrupts,” or “alerts.”

### BRIEF DESCRIPTION OF THE DRAWINGS

The present invention provides a system and method for generating an event notification of an event occurring in connection with a computer system or network process to a software program that requires such notification through the use of a single intermediary program.

FIG. 1 is a flow diagram of a first embodiment of the invention.

FIG. 2 is a flow diagram of a second embodiment of the invention.

FIG. 3 is a block diagram of a third embodiment of the invention.

### DETAILED DESCRIPTION

Broadly stated, the present invention is directed to a system and method for generating an event notification, e.g., a “trap,” “interrupt,” or “alert,” by providing information concerning an event occurring in connection with a process running on a computer system or network to a single intermediary program. This single intermediary program forms a data packet, e.g., a “trap packet,” and sends it to a software program that is to be notified of the event.

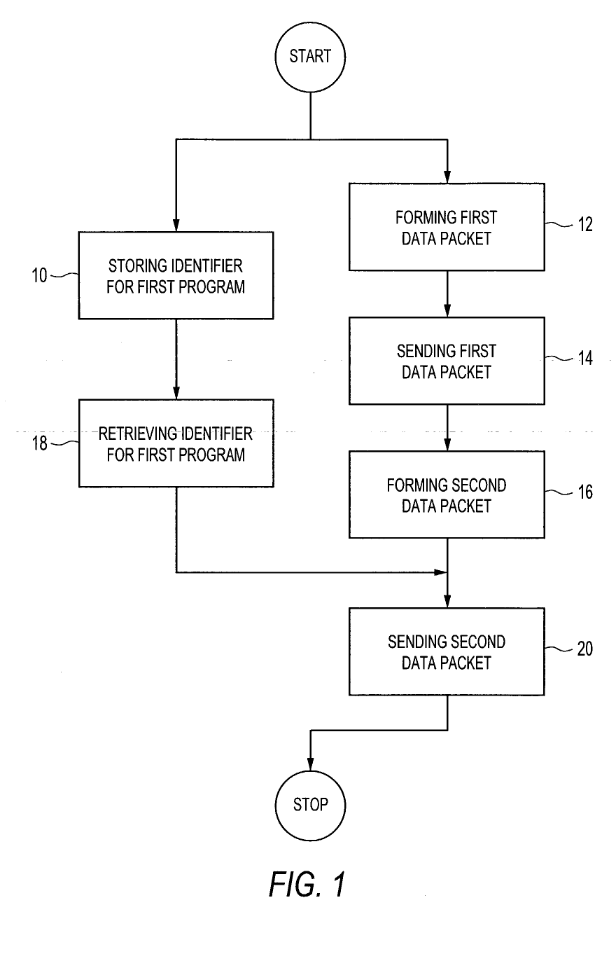

Turning now to FIG. 1, a flow diagram of an embodiment of the invention is shown. An identifier for a first software program that is to be notified of an event occurring in connection with a process is stored (10). The first software program may be a management application used to manage a computer network, including but not limited to a management application used in SNMP, and further including but not limited to an external management application used in SNMP. The process may include a software program for the operation of a hardware device, e.g., a print server. After the event occurs, the process in connection with which the event occurs forms a first data packet that includes an event identifier identifying the event and instructions to write the event identifier to a second software program (12). The second software program may be an agent such as that used in SNMP. The first data packet may be a set packet and the event identifier an object identifier including but not limited to those used in SNMP. The process sends the data packet it has formed to the second software program (14).

The second software program forms a second data packet that includes the event identifier (16). The second software program retrieves the identifier for the first software program to be notified of the event (18). This second data packet formed by the second software program may be a trap packet including but not limited to a trap packet used in SNMP. The storing of the event identifier 10 need not take place before the process forming a first data packet 12 but must take place before the retrieving 18. The second software program sends the data packet it has formed to the first software program (20). The retrieving 18 need not take place after the forming 16 but must take place before the sending 20.

In an embodiment of the invention, the process sends the data packet formed by the process (14) through a loopback address.

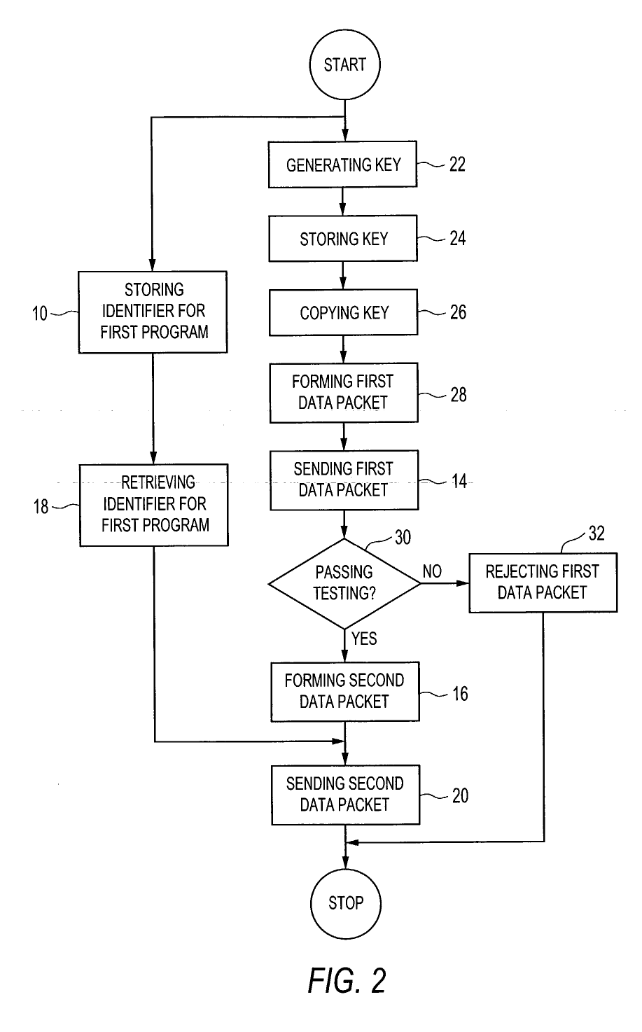

Turning now to FIG. 2, a flow diagram of an embodiment of the invention that includes generating a key (22), storing the key (24), and testing based on the key (30) is shown. The generating of the key 22 and the storing of the key 24 need not take place after the event to be notified to a first software program, but they must take place before a copying of the key (26). An identifier for a first software program that is to be notified of an event occurring in connection with a process is stored (10). The first software program may be a management application used to manage a computer network, including but not limited to a management application used in SNMP, and further including but not limited to an external management application used in SNMP. The process may include a software program for the operation of a hardware device, e.g., a print server. After the event in connection with the process, the process copies the key (26) and forms a first data packet, including the key at a particular location in the first data packet and further including an event identifier identifying the event and instructions to write the event identifier to a second software program (28). The generating of the key 22 and the storing of the key 24 need not take place after the event to be notified to a first software program, but they must take place before a copying of the key 26. The first software program may be a management application used to manage a computer network, including but not limited to a management application used in SNMP, and further including but not limited to an external management application used in SNMP. The process may include a software program for the operation of a hardware device, e.g., a print server. The second software program may be an agent including but not limited to that used in SNMP. The first data packet may be a set packet and the event identifier an object identifier including but not limited to those used in SNMP. The process sends the first data packet to a second software program (14).

The second software program tests the identity and the position of the key in the first data packet (30). If first data packet fails the testing 30, the second software program rejects the data packet and generates an error message (32). If the first data packet passes the testing 30, the second software program forms the second data packet (16), retrieves the identifier for the first software program (18) and sends second data packet to the first software program (20). This second data packet formed by the second software program may be a trap packet including but not limited to a trap packet used in SNMP. The second software program retrieving the identifier for the management application does not necessarily take place before or after the testing is performed but must take place before the sending 20.

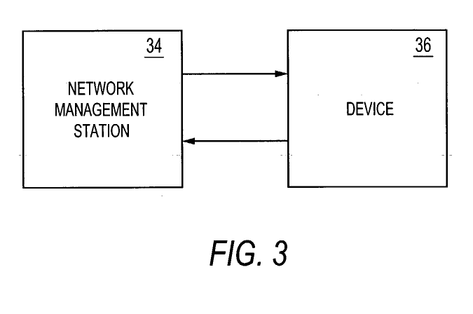

Turning now to FIG. 3, an embodiment of the invention comprising a computer network comprising a network management station (34) and a device (36) that is operably coupled to station 34 is shown. The computer network further comprises a software agent such as the agent used in SNMP (not shown). The agent is programmed to retrieve a station identifier for station 34, the identifier identifying station 34 as a station to be notified of an event occurring in connection with a process. The agent is further programmed to receive data from the process in connection with which the event may occur, the process being capable of creating a set packet after said event occurs, including an identifier of said event, and sending the set packet to the device 36. The agent is further programmed to create a trap packet including the identifier of the event and to send the trap packet to station 34 identified by the station identifier. Station 34 is further programmed to receive the trap packet from the agent.

It is contemplated that embodiments of the invention include but are not limited to use of various protocols and software programs designed for the management of computer systems and networks, e.g., SNMP in all available versions and applicable specifications (including but not limited to SNMP1, SNMPv2, and SNMPv3; and the SNMP specifications contained in Requests for Comments (“RFCs”) promulgated by the Internet Engineering Task Force (“IETF”)); Hewlett-Packard's OPENVIEW® SNMP suite; and Net-SNMP (formerly known as University of California at Davis SNMP (UCD-SNMP) Project), SNMP++, Agent++, Emanate®, and Envoy™ agent software.

While various embodiments of the present invention have been shown and described, it should be understood that other modifications, substitutions, and alternatives are apparent to one of ordinary skill in the art. Such modifications, substitutions, and alternatives can be made without departing from the spirit and scope of the invention, which should be determined from the appended claims.

Various features of the present invention are set forth in the appended claims.

What is claimed is:

1. A method of generating an event notification, the method comprising:
storing an identifier identifying a first software program, the first software program to be notified of an event in connection with a process;
said process forming a first data packet after said event,
said first data packet including
at least one item and
an instruction to write said at least one item to a second software program, said at least one item including at least one event identifier identifying said event;
said process sending said first data packet to said second software program;
said second software program forming a second data packet using said at least one event identifier;
said second software program retrieving said identifier identifying said first software program; and
said second software program sending said second data packet to said first software program.

2. The method recited in claim 1, wherein
the method uses Simple Network Management Protocol.

3. The method recited in claim 1, wherein
the first computer program is a management application.

4. The method recited in claim 1, wherein
the second computer program is an agent.

5. The method recited in claim 1, wherein
the first data packet is a set packet.

6. The method recited in claim 1, wherein
the second data packet is a trap packet.

7. The method recited in claim 1, wherein
the event identifier is a object identifier.

8. The method recited in claim 1, wherein
said process sending said first data packet to said second software program sends said first data packet through a loopback address.

9. The method recited in claim 1, further comprising:
said second software program testing said first data packet.

10. A method for generating an event notification, the method comprising:
storing an identifier identifying a management application, said management application to be notified of an event in connection with a process;
said process forming a set packet after said event,
said set packet including
at least one item and
an instruction to write said at least one item to an agent, said at least one item including at least one object identifier identifying said event;
said process sending said set packet to said agent through a loopback address;
said agent testing said set packet;
said agent forming a trap packet using said at least one object identifier;
said agent retrieving said identifier identifying said management application; and
said agent sending said trap packet to said management application; and
wherein the method uses Simple Network Management Protocol.

11. A method of generating an event notification, the method comprising:
generating a key;
storing said key;
storing an identifier identifying a first software program that is to be notified of an event in the context of a process;
said process retrieving said stored key;
said process forming a first data packet after said event,
said first data packet including
at least one item,
an instruction to write said at least one item to a second software program, said at least one item including at least one event identifier identifying said event, and
a copied key, said copied key being a copy of said stored key,
said process sending said first data packet to said second software program;
said second software program testing said first data packet for an identity of said copied key and said stored key;
if said first data packet fails said testing for said identity, said second software program rejecting said first data packet;
if said first data packet passes said testing for said identity, said second software program forming a second data packet using said at least one event identifier;
said second software program retrieving said identifier identifying said first software program; and
said second software program sending said second data packet to said first software program.

12. The method recited in claim 11, wherein
the method uses Simple Network Management Protocol.

13. The method recited in claim 12, wherein
said storing an identifier identifying said first software program uses a table selected from the group consisting of snmpTargetAddrTable, snmpTargetParamsTable, snmpNotifyTable, snmpNotifyFilterProfileTable, and snmpNotifyFilterTable.

14. The method recited in claim 11, wherein
said generating said key is performed at system startup.

15. The method recited in claim 11, wherein
said first computer program is a management application.

16. The method recited in claim 11, wherein
said second computer program is an agent.

17. The method recited in claim 11, wherein
said first data packet is a set packet.

18. The method recited in claim 11, wherein
said second data packet is a trap packet.

19. The method recited in claim 11, wherein
said event identifier is an object identifier.

20. The method recited in claim 11, wherein
said process sending said first data packet to said second software program sends said first data packet through a loopback address.

21. The method recited in claim 11, further comprising:
if said first data packet fails said testing for said identity, said second software program generating an error message.

22. The method recited in claim 21, wherein
said error message includes “‘2’ NOSUCHNAME”.

23. The method recited in claim 11, wherein
said copied key is in a specific position within said first data packet; and
further comprising:
said second software program testing said first data packet to verify that said copied key is in said specific position within said first data packet.

24. The method recited in claim 23, wherein
said specific position in said first data packet is in an event identifier in an initial variable binding of at least one variable binding in said first data packet.

25. A method for generating an event notification, wherein
the method uses Simple Network Management Protocol; and
the method comprising:
storing an identifier identifying a management application that is to be notified of an event in connection with a process, said storing including use of a table selected from the group consisting of snmpTargetAddrTable, snmpTargetParamsTable, snmpNotifyTable, snmpNotifyFilterProfileTable, and snmpNotifyFilterTable;
generating a key at system startup;
storing said key, wherein said stored key is accessible to said process and an agent;
said process retrieving said stored key;
said process forming a set packet after said event,
said set packet including
at least one item,
an instruction to write said at least one item to an agent, said at least one item including at least one object identifier identifying said event, and
a copied key, said copied key being a copy of said stored key, said copied key being in a specific position in said set packet, said specific position in said set packet being in an object identifier in an initial variable binding of at least one variable binding in said set packet;
said process sending said set packet to said agent through a loopback address;
said agent testing said set packet
for an identity of said copied key with said stored key, and
to verify that said copied key is in said specific position within said first data packet;
if said set packet fails said testing for said identity or for said specific position, said agent rejecting said set packet and generating an error message, said error message including “‘2’ NOSUCHNAME”;
if said set packet passes said testing for said identity or for said specific position, said agent forming a trap packet using said at least one object identifier;
said agent retrieving said identifier for said management application; and
said agent sending said trap packet to said management application.

26. A method for generating an event notification, the method comprising:
storing an identifier identifying a management application, said management application to be notified of an event in connection with a process;
said process forming a set packet after said event,
said set packet including
at least one item and
an instruction to write said at least one item to an agent, said at least one item including at least one object identifier identifying said event;
said process sending said set packet to said agent;
said agent forming a trap packet using said at least one object identifier;
said agent retrieving said identifier identifying said management application;
said agent sending said trap packet to said management application.

27. The method recited in claim 26, wherein
said process sending said set packet to said agent sends said set packet through a loopback address.

28. The method recited in claim 26, further comprising:
said agent testing said set packet.

29. A method for generating an event notification, the method comprising:
storing an identifier identifying a management application that is to be notified of an event in connection with a process;
generating a key;
storing said key;
said process retrieving said stored key;
said process forming a set packet after said event,
said set packet including
a copied key, said copied key being a copy of said stored key,
at least one item, and
an instruction to write said at least one item to an agent, said at least one item including at least one object identifier identifying said event;
said process sending said set packet to said agent;
said agent testing said set packet for an identity of said copied key and said stored key;
if said set packet fails said testing for said identity, said agent rejecting said first data packet;
if said set packet passes said testing for said identity, said agent forming a trap packet using said at least one object identifier;
said agent retrieving said identifier for said management application; and
said agent sending said trap packet to said management application.

30. The method recited in claim 29, wherein
said process sending said set packet to said agent sends said set packet through a loopback address.

31. The method recited in claim 29, further comprising:
if said set packet fails said testing, said agent generating an error message.

32. The method recited in claim 31, further comprising:
said error message including “‘2’ NOSUCHNAME”.

33. The method recited in claim 29, wherein
said copied key is in a specific position within said set packet; and
further comprising:
said agent testing said set packet for said specific position of said copied key in said set packet.

34. The method recited in claim 33, further comprising:
if said set packet fails said testing for said specific position, said agent rejecting said set packet.

35. The method recited in claim 34, further comprising:
if said set packet fails said testing for said specific position, said agent generating an error message.

36. The method recited in claim 35, further comprising:
said error message including “‘2’ NOSUCHNAME”.

37. A computer-readable medium having computer-readable instructions for performing a method of generating an event notification, the method comprising:
storing an identifier identifying a first software program, the first software program to be notified of an event in connection with a process;
said process forming a first data packet after said event,
said first data packet including
at least one item and
an instruction to write said at least one item to a second software program, said at least one item including at least one event identifier identifying said event;
said process sending said first data packet to said second software program;
said second software program forming a second data packet using said at least one event identifier,
said second software program retrieving said identifier identifying said first software program; and
said second software program sending said second data packet to said first software program.

38. A computer-readable medium having computer-readable instructions for performing a method of generating an event notification, the method comprising:
generating a key;
storing said key;
storing an identifier identifying a first software program that is to be notified of an event in the context of a process;
said process retrieving said stored key;
said process forming a first data packet after said event,
said first data packet including
at least one item,
an instruction to write said at least one item to a second software program, said at least one item including at least one event identifier identifying said event, and
a copied key, said copied key being a copy of said stored key,
said process sending said first data packet to said second software program;
said second software program testing said first data packet for an identity of said copied key and said stored key;
if said first data packet fails said testing for said identity, said second software program rejecting said first data packet;
if said first data packet passes said testing for said identity, said second software program forming a second data packet using said at least one event identifier;
said second software program retrieving said identifier identifying said first software program; and
said second software program sending said second data packet to said first software program.

39. An apparatus comprising:
a memory; and
at least one processor
operatively coupled to said memory,
programmed with a first software program,
programmed with a second software program,
programmed to run a process in connection with which said event may occur, said process
capable of creating a first data packet after said event occurs, including
at least one item, said at least one item including at least one event identifier of said event and
an instruction to write said item to said second software program, and
capable of sending said first data packet to said second software program;
programmed to store an identifier identifying said first software program;
wherein said second software program is
capable of receiving said first data packet from said process,
capable of creating a second data packet, said second data packet including said event identifier,
capable of retrieving said identifier identifying said first software program, and
capable of sending said second data packet to said first software program; and
wherein said first software program is capable of receiving said second packet from said second software program.

40. The apparatus recited in claim 39, wherein
the apparatus is programmed to use Simple Network Management Protocol.

41. The apparatus recited in claim 39, wherein
said first computer program is a management application.

42. The apparatus recited in claim 39, wherein
said second computer program is an agent.

43. The apparatus recited in claim 39, wherein
said first data packet is a set packet.

44. The apparatus recited in claim 39, wherein
said second data packet is a trap packet.

45. The apparatus recited in claim 39, wherein
said event identifier is a object identifier.

46. The apparatus recited in claim 39, wherein
said process is capable of sending said first data packet to said second software program through a loopback address.

47. The apparatus recited in claim 39, further comprising:
said second software program is capable of testing said first data packet.

48. An apparatus comprising:
a memory; and
at least one processor
operatively coupled to said memory,
programmed with a management application,
programmed with an agent,
programmed to run a process in connection with which said event may occur, said process capable of
capable of creating a set packet after said event occurs, including
at least one item, said at least one item including at least one object identifier identifying said event and
an instruction to write said item to said agent, and
capable of sending said set packet to said agent through a loopback address;
programmed to store an identifier identifying said management application;
wherein said agent is
capable of receiving said set packet from said process,
capable of testing said set packet,
capable of creating a trap packet, said trap packet including said at least one object identifier,
capable of retrieving said identifier identifying said management application,
capable of sending said trap packet to said management application;
wherein said management application is capable of receiving said trap packet from said agent; and
wherein the apparatus uses Simple Network Management Protocol.

49. A computer network comprising:
a network management station;
a device operably coupled to said network management station; and
a software agent
programmed to monitor said device,
programmed to retrieve an identifier for said network management station, the identifier identifying said network management station as a network management station to be notified of an event occurring in connection with a process,
programmed to receive data from said process in connection with which said event may occur, said process capable of
creating a set packet after said event occurs, including
at least one item, said at least one item including at least one object identifier identifying said event and
an instruction to write said item to said device, and
sending said set packet to said agent;
programmed to receive said set packet from said process,
programmed to create a trap packet, said trap packet including said at least one object identifier,
programmed to send said trap packet to said network management station identified by said identifier; and
wherein said network management station is programmed to receive said trap packet from said device.

50. The computer network recited in claim 49, wherein
said process is capable of sending said set packet to said agent through a loopback address.

51. The computer network recited in claim 49, wherein
said agent is programmed to test said set packet.

52. An apparatus for generating an event notification, the apparatus comprising:
means for identifying a first software program that is to be notified of an occurrence of an event in connection with a process;
means for said process to notify a second software program of said occurrence of said event, including
means for forming a first data packet incorporating at least one event identifier;
means for transmitting said first data packet from said process to said second software program;
means for said second software program forming a second data packet incorporating said at least one event identifier; and
means for transmitting said second data packet from said second software program to said first software program.

53. An apparatus for generating an event notification, the apparatus comprising:
means for identifying a management application that is to be notified of an occurrence of an event in connection with a process;
means for the process to notify an agent of said occurrence of said event, including
means for forming a set packet incorporating at least one event identifier;
means for transmitting the set packet from the process to the agent;
means for said agent to form a trap packet incorporating said at least one event identifier; and
means for transmitting said trap packet from said agent to said management application.

54. An apparatus for generating an event notification, the apparatus comprising:
means for generating a key;
means for storing said key;
means for identifying a first software program that is to be notified of an occurrence of an event in connection with a process;
means for said process to notify a second software program of said occurrence of said event, including
means for forming a first data packet incorporating at least one event identifier,
an instruction to write said at least one event identifier to said second software program, and
a copied key, said copied key being a copy of said stored key;
means for transmitting said first data packet from said process to said second software program;
means for second software program to test said first data packet including
means for testing said first data packet for an identity of said copied key with said stored key;
means for second software program to reject said first data packet if said means for testing finds that said first data packet fails said testing for said identity;
means for forming a second data packet incorporating said event identifier if said means for testing finds that first data packet passes said testing for identity; and
means for transmitting said second data packet from said second software program to said first software program.

55. The apparatus recited in claim 54, wherein
the apparatus uses Simple Network Management Protocol.

56. The apparatus recited in claim 54, wherein
said first software program is a management application.

57. The apparatus recited in claim 54, wherein
said means for identifying a first software program include storing an identifier in a table selected from the group consisting of snmpTargetAddrTable, snmpTargetParamsTable, snmpNotifyTable, snmpNotifyFilterProfileTable, and snmpNotifyFilterTable.

58. The apparatus recited in claim 54, wherein
said means for generating said key generates said key at system startup.

59. The apparatus recited in claim 54, wherein
said second software program is an agent.

60. The apparatus recited in claim 54, wherein
said first data packet is a set packet.

61. The apparatus recited in claim 54, wherein
said second data packet is a trap packet.

62. The apparatus recited in claim 54, wherein
said event identifier is an object identifier.

63. The apparatus recited in claim 54, wherein
said means for transmitting said first data packet from said process to said second software program sends said first data packet through a loopback address.

64. The apparatus recited in claim 54, further comprising:
means for said second software program to generate an error message if said means for testing finds that said first data packet fails said testing for said specific position.

65. The apparatus recited in claim 64, wherein
said error message includes “‘2’ NOSUCHNAME”.

66. The apparatus recited in claim 54, wherein
said means for forming said first data packet further include means for incorporating said copied key in a specific position in said first data packet; and
further comprising:
means for said second software program to test said first data packet to verify that said copied key is in said specific position within said first data packet.

67. The apparatus recited in claim 66, further comprising:
means for said second software program to generate an error message if said means for testing finds that said first data packet fails said testing for said specific position.

68. The apparatus recited in claim 66, wherein
said specific position in said first data packet is in an event identifier in an initial variable binding of at least one variable binding in said first data packet.

69. An apparatus for generating an event notification, the apparatus comprising:
means for identifying a management application that is to be notified of an occurrence of an event in connection with a process, wherein said means for identifying a management application includes storing an identifier in a table selected from the group consisting of snmpTargetAddrTable, snmpTargetParamsTable, snmpNotifyTable, snmpNotifyFilterProfileTable, and snmpNotifyFilterTable;
means for said process to notify an agent of said occurrence of said event, including
means for forming a set packet incorporating
an object identifier identifying said event and
an instruction to write said object identifier to said agent;
means for transmitting said set packet from said process to said agent through a loopback address;
means for testing said set packet including
means for generating a key at system startup,
means for storing said stored key,
means for incorporating a copy of said stored key in a specific position in said set packet, said specific position of said copied key in said set packet being in an object identifier in an initial variable binding of at least one variable binding in said set packet,
means for testing said set packet for an identity of said copied key with said stored key, and
means for testing said set packet to verify that said copied key is in said specific position within said set packet;
means for rejecting said set packet if said means for testing finds that said set packet fails said testing for said specific position or said identity;
means for generating an error message if said means for testing finds that said set packet fails said testing for said specific position or said identity, said error message including “‘2’ NOSUCHNAME”.
means for forming a trap packet incorporating said object identifier if said means for testing finds that said set packet passes said testing for said specific position or said identity; and
means for transmitting said trap packet from said agent to said management application; and
wherein the apparatus uses Simple Network Management Protocol.
